(19) United States
(12) Patent Application Publication
(10) Pub. No.: US 2020/0016498 A1
(43) Pub. Date: Jan. 16, 2020

(54) METHODS AND SYSTEMS FOR MANAGING A FANTASY COMPETITION

(71) Applicant: Starting 11 LLC, Minneapolis, MN (US)

(72) Inventors: William Teague Orgeman, Minneapolis, MN (US); Thomas John Braun, Minneapolis, MN (US)

(21) Appl. No.: 16/108,569

(22) Filed: Aug. 22, 2018

Related U.S. Application Data
(60) Provisional application No. 62/584,185, filed on Nov. 10, 2017.

(51) Int. Cl. A63F 13/828; A63F 13/35

(52) U.S. Cl. CPC A63F 13/828; A63F 13/35

(57) ABSTRACT

Methods and systems for managing a fantasy competition. The methods and systems include creating a fantasy competition, enrolling participants, beginning the competition, providing data to participants during the competition, finishing the competition, and determining a winner. Participants may create a teams from a plurality of available athletes such as from a predetermined list of athletes. Participants may modify their teams to include or remove athletes, such as prior to or after the beginning of the competition. The modifications may be limited in number. The modifications may occur while at least one of the athletes is competing in a real-world sporting event. The winner may be determined by awarding points to participants based on the composition of the participants' team. The points awarded may correspond to the real-world performance of the athletes on the participants' team, such as while the athletes were included on the participants' team.

### BACKGROUND

Fantasy sports are competitions in which participants select professional athletes for their own fantasy teams. Throughout the competition, points are generally awarded to the participants' fantasy teams based on the real-world performance of the selected athletes. At the end of the competition, the winning participants are determined from the sum of these points. Depending upon the sport and the participants' preferences, the competition could continue for an entire season of the sport or even multiple seasons, but may also last a shorter amount of time, such as a portion of a season, a tournament, or even a single day. Participants are often able to monitor the performance of their athletes and other eligible athletes to decide which athletes to keep on their teams and which athletes to change in their lineups.

Generally, participants are only allowed to change the selection of athletes in their lineups at certain predetermined times. For example, once a real-world game begins, fantasy competitions no longer allow a participant to change the athletes in the participant's lineup. As such, at a certain point, such as at the time of kickoff, the athletes become locked into the participant's fantasy team. While the participant may passively watch the athletes' performances, the participant is no longer able to engage in the fantasy sport with that athlete, especially while an athlete is engaged in a real-world competition. Thus, prior art methods and systems for managing fantasy sports generally fail to provide their participants a dynamic, authentic, and interactive way to experience the real-world sports.

The present invention improves upon the prior art methods and systems for managing fantasy sports by offering, for example, real-time player substitution. For example, the present invention may permit participants to add, remove, or replace athletes while those athletes are competing in a real-world game or match. An advantage of the present invention includes allowing fantasy competition participants to interact with real-time data and technology to turn watching a real-world sporting event from a passive to an active experience.

### SUMMARY

Various embodiments include methods of managing a fantasy competition including creating a fantasy competition, enrolling of a plurality of participants, beginning the fantasy competition, providing data to the plurality of participants during the fantasy competition, finishing the fantasy competition, and determining a winner amongst the plurality of participants. In some embodiments, the enrolling of a plurality of participants includes allowing each of the plurality of participants to create a team from a plurality of available athletes. In some such embodiments, the plurality of available athletes includes a predetermined list of athletes. In some embodiments, the method includes permitting each of the plurality of participants to modify the team to include or remove any of the plurality of available athletes.

In some embodiments, the method may permit each of the plurality of participants to modify the team to include or remove any of the plurality of available athletes prior to or after the step of beginning the fantasy competition. In some embodiments, the modifications may be limited in number. In some embodiments, the modifications may occur while at least one of the available athletes is competing in a real-world sporting event.

In some methods, the step of determining a winner among the plurality of participants includes awarding points to each participant based on the composition of the participants' team. For example, in some embodiments the points awarded correspond to the real-world performance of the available athletes on the participants' team, such as the real-world performance of the available athletes while the available athletes were included on the participants' team.

Various embodiments also include methods of managing a fantasy competition including creating a fantasy competition, enrolling of a plurality of participants, wherein each of the plurality of participants creates a team from a plurality of available athletes, beginning the fantasy competition, permitting each of the plurality of participants to modify the team to include or remove any of the plurality of available athletes prior to or after the beginning of the fantasy competitions, providing data to the plurality of participants during the fantasy competition, finishing the fantasy competition, and determining a winner amongst the plurality of participants. In some embodiments, the modifications permitted by the step of permitting each of the plurality of participants to modify the team to include or remove any of the plurality of available athletes may be limited in number. In some embodiments, the modifications may occur while at least one of the available athletes is competing in a real-world sporting event. In some embodiments, the step of determining a winner among the plurality of participants includes awarding points to each participant based on the composition of the participants' team. In some embodiments, the points awarded correspond to the real-world performance of the available athletes on the participants' team. For example, in some embodiments, the points awarded correspond to the real-world performance of the available athletes while the available athletes were included on the participants' team.

Various embodiments may further include methods computer-implemented fantasy competition management systems including a competition server configured to create a fantasy competition, enroll of a plurality of participants, begin the fantasy competition, permit each of the plurality of participants to modify the team to include or remove any of the plurality of available athletes prior to or after the beginning the fantasy competitions, provide data to the plurality of participants during the fantasy competition, finish the fantasy competition, and determine a winner amongst the plurality of participants. In some embodiments, the permitted modifications are limited in number and may occur while at least one of the available athletes is competing in a real-world sporting event. In some embodiments, the determination of a winner among the plurality of participants includes awarding points to each participant based on the composition of the participants' team. In some embodiments, the points awarded correspond to the real-world performance of the available athletes on the participants' team while the available athletes were included on the participants' team.

### BRIEF DESCRIPTION OF THE DRAWINGS

The following drawings are illustrative of embodiments and do not limit the scope of the invention. The drawings are not necessarily to scale and are intended for use in conjunction with the following detailed description. Embodiments of the invention will be described with reference to the drawings, in which like numerals may represent like elements.

FIG. 1 is a representation of a system according to various embodiments, and

FIG. 2 is a diagram of a method of managing a fantasy sport according to various embodiments.

### DETAILED DESCRIPTION

The present application claims priority to provisional application No. 62/584,185 filed Nov. 10, 2017 entitled Methods and Systems for Playing a Fantasy Sport. The following detailed description is exemplary in nature and is not intended to limit the scope, applicability, or configuration of the invention. Rather, the following description provides practical illustrations for implementing various exemplary embodiments. Utilizing the teachings provided herein, those skilled in the art may recognize that many of the examples have suitable alternatives that may be utilized.

Various systems and methods described herein provide fantasy sports games or competitions on a computerized format, such as an application on a portable computing device, which allow for live substitution of athletes during their games, providing an interactive experience for the users that allows them to act more like real team managers. The present invention may also be utilized in other formats, including an internet-based competition.

The systems and methods described herein may be used with any sport or competition, including but not limited to professional sports and college sports. Soccer (also known at football outside the United States) is a particularly appropriate sport for various embodiments and will be used as the primary example throughout this application. However, it should be understood that the inventions described herein may alternatively be used for other sports or competitions including team sports, particularly team sports having changing dynamics during play, such as hockey, football, baseball, and basketball.

The exemplary methods and processes described herein may be performed using a system which may include digital electronic circuitry of various types including integrated circuits, hardware, software, and/or other components in various combinations. It may include machine readable medium such any type of memory which may be used to provide machine instructions and/or data to a processor, which may implement the methods described herein using one or more computer programs. The machine readable medium may store machine instructions in a non-volatile or non-transient manner (such as in a solid state medium) and/or in a transient manner (such as in a cache or random access memory).

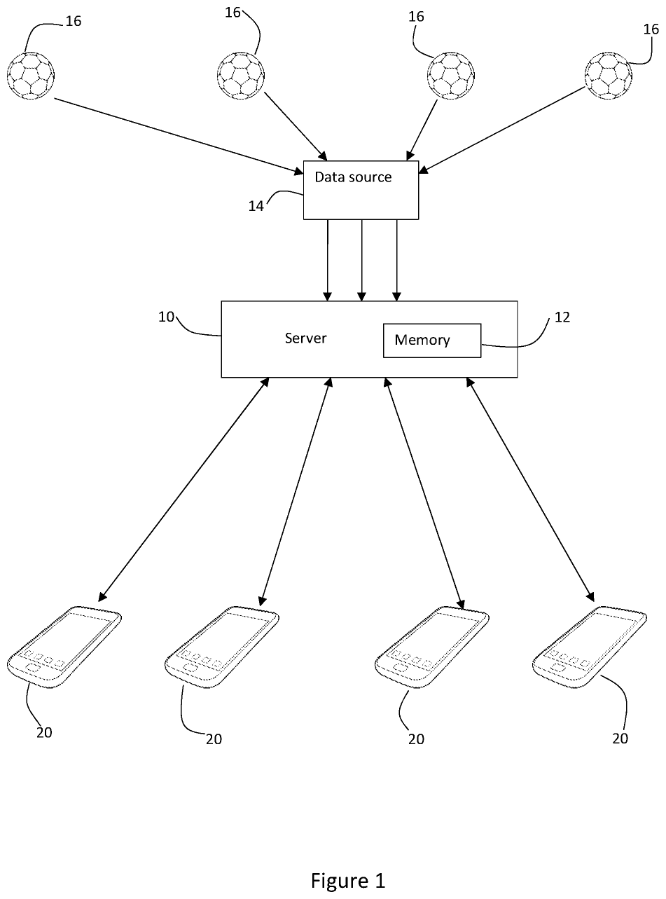

An example of a system that may be used in various embodiments is shown in FIG. 1. The system includes one or more servers such as server 10 for processing and one or more memory components 12 which may be part of and/or separate from the server 10. The server 10 may be configured to execute programming to perform the various steps described herein. The memory 104 may store data such as data and statistics regarding athletes, athletes' images, graphics associated with each athlete (such as colors and/or jerseys corresponding to the athletes' real teams), game schedules, and logs of the contests. For example, logs of the contests may include data for each user, the user's lineup, when substitutions were made during the contest, the athlete's data and scores across time throughout the contest, and the user's score across time throughout the contest. The memory 104 may further store programs such as an operating system and one or more application programs which operate on the server 10.

The server 10 is in digital communication with one or more data sources 14, such as through the internet. The data source 14 may supply information regarding a plurality of games 16 such as soccer matches or other sporting events including the ongoing real time performance of the athletes participating in the games 16. The data source may be provided by an outside service such as that provided by Opta Sports or Sport Radar. These services employ individuals to watch live sporting events and instantly code and enter the athletes' performance data into a computer system and/or automatically gather data regarding the athletes' performance during a sporting event and then stream the data to customers, such as through a data feed. Data may be provided together in a single stream or different types or sets of data may be streamed to the one or more servers 10 through a plurality of data streams. One or more servers 10 may receive this data from data source 14 and apply the system programming to convert the data into points which it then streams to users.

The server 10 may communicate with users through the internet, for example. Users may employ user devices 20 such as mobile computing devices like smart phones or tablets, or computers such as personal computers or laptops, each having interfaces such as screens, processors, non-volatile memory, programming, and input and output units. The user devices 20 may employ mobile applications or may comprise devices or programs or website interfaces on personal computers or tablets.

The fantasy competition may occur during a certain limited period of time. This period of time may be a single day, such as a 24 hour calendar day. Alternatively, the period of time may be two or three days, a weekend, a week, multiple weeks, a month, multiple months, or the entire season of the sport. The period of time may alternatively comprise a single game, a tournament, a partial season of a given sport, an entire season of a given sport, or a plurality of seasons of a given sport. In some embodiments, since users are able to actively manage their teams during the contests, user engagement may be high and shorter time periods such as a single day may be appropriate or preferred.

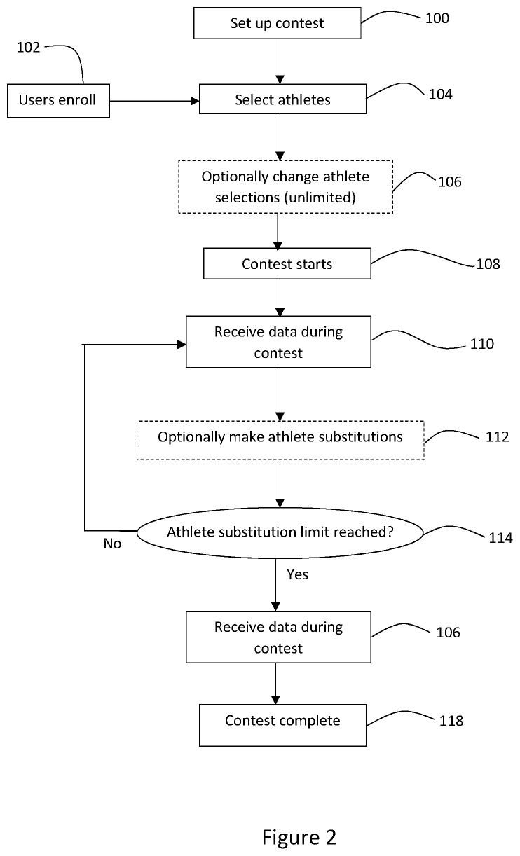

One method of managing a fantasy competition is shown in FIG. 2. In a first step 100, a contest is set up, either by a user 20 or by the system 10. For example, the system 10 may automatically create one or more contests for various time periods, such as one or more one day contests on various days on which athletic events are occurring, and these contests may have the same parameters or different parameters. In setting up a contest in step 100, the number of users may or may not be limited. If the number of users is limited, when a system created contest fills with the maximum allowed number of users, the system 10 may automatically set up another contest for the same time, having the same or different parameters as the filled contest, and this may repeat as long as users 20 continue to sign up for the contests, until the start of the contest. In such contests, the system 10 may automatically determine the contest parameters. Alternatively, users 20 may set up contests and may select one or more or all of the parameters of the contest. For example, parameters which the system or the user may select for the contest may include one or more of: the type of sport; the specific league or leagues within that sport; how many users may participate in the contest; whether the contest is open to all users (public) or only to a select group of users (private); when the contest will begin and end; how the winners will be selected (e.g. the single user with the most points, a split amongst the users scoring in the top half, etc.); and any other contest details.

In some embodiments, the contest may be played for real-world currency or money, with users paying to enter and winning money if they win the contest according to the contest rules, and the user may set up the associated parameters such as setting the entry fee. In other embodiments, the contest may be available to users 10 without the exchange of any real-world currency, money, or financial obligation.

Once the contest is established in step 100, other users may also enroll in the contest at step 102. For example, a user may search for contests to enter by one or more of sport, contest date, league, etc. and may select a desired contest.

In step 104, before the contest begins, users 20 may select athletes for their teams. For example, users 20 may find athletes for their teams by searching for athletes by name, position, team, past performance statistics, percent owned by other contestants, etc. and this data may be displayed for the user 20 on a user interface along with a real or stylized image of the athlete. A user 20 may select an athlete by clicking on the athlete image or a selection button graphic, for example.

The system 10 may include rules for athlete eligibility for placement on a team which may depend upon the sport. For example, to be eligible for selection on a user's team, the athletes must be participating in one or more games during the duration of the contest. That is, the system 10 may restrict the pool of eligible athletes to athletes who are participating in a real-world game during the pendency or duration of the specified contest. The system 10 may further require the users 20 to select athletes for specific positions according to the athletes' positions in the sport. For example, in one embodiment of the invention, the system 10 may require the user 20 to select a certain number of defensive players to fill a certain number of defensive slots on the fantasy team of user 20. The system 10 may further require the users 20 to select a captain. The selection of a captain by user 20 may entitle user 20 to gain additional points for the fantasy team, such as double points or any other multiplier permitted by system 10.

A common feature of fantasy competitions is the use of a salary cap in which each athlete is assigned a cost based upon the athlete's past performance, and the total cost of all athletes on a user's team is limited to a capped amount. For some sports and/or for some contests (such as at the preference of the user establishing the contest), the system 10 may include a salary cap for the teams such that each athlete is assigned a cost based upon past performance. Alternatively, in some embodiments of the present invention, the system 10 may include no salary cap such that users may select any athletes they want to fill the positions on their team. By eliminating the salary cap, it may be more difficult for certain users 20 (sometimes referred to as professional players) to gain an advantage through the use of algorithms to mathematically calculate, based on the athlete's performance, the value of the athlete in dollars per point to maximize their likelihood of winning under the cost constraints of a salary cap. Without the use of a salary cap, the advantage gained through the use of such algorithms is diminished and information is more equal among users 20.

The system 10 may allow more than one user 20 to select an athlete for the user's team. Because of this, in some rare cases, two or more users 20 may make similar or identical assessments of the available athletes and may begin a contest with identical teams. However, because the system 10 may allow for the substitution of athletes during the contest, the makeup of the teams is likely to diverge during the contest such that it is highly unlikely that such users 20 would finish the contest with the same score. That is, while it is possible for users 20 to begin the contest with identical teams, the users 20 may make different substitutions during the contest and, as a result, their teams are likely to become different during the contest and therefore the users' teams will have different final scores.

In step 106, users 20 may alter or change their athlete selections prior to the start of the contest (which may serve as a cutoff time for unlimited substitutions). Changes to the selected athletes may be unlimited from all athletes available for the contest. The user 20 may repeat this step as many times as desired, changing the selected athletes many times, or a user 20 may omit this step and continue with the team of athletes as selected originally. The cutoff time may be the scheduled or actual starting time of the first game in the league or leagues to which the contest applies, such as the actual or scheduled kickoff time, or may be the scheduled or actual starting time of the first game in which an athlete selected for a user's team or for any team in the contest is participating. Alternatively, the cutoff time may be a set time prior to the scheduled starting time first game in the league or leagues to which the contest applies. In another embodiment, users 20 may not be able to alter or change the selection of athletes made at step 104.

At step 108 the competition begins and any changes to the athletes on the user's team may now be restricted by system 10.

During the competition or contest, the user 20 may receive data from the system 10 in step 110. This data may include the points earned by each of the user's athletes, the user's total points from the team, the user's standing. The data may stream to the user through an application on the user's mobile device, and may include push or instant notifications for important events such as real game substitutions, injuries, or ejections involving a user's athlete, and game delays.

Because a user 20 may be permitted to make substitutions after the competition or contest has begun at step 108, certain users 20 are likely to be engaged with and in communication with the system 10 and watching the inflow of data regarding the user's athletes. However, in order to increase user engagement and enjoyment, the system 10 may include scoring methods that result in more point fluctuations than in typical fantasy sports. Exemplary embodiments of such scoring methods are described below.

In some embodiments, the system 10 may award both whole points and partial points (in the form of non-whole numbers) in order to track a greater number of athlete activities and to a finer granularity. For example, in a soccer contest the system 10 may award whole points to athletes for actions that are typically included in fantasy soccer such as scoring a goal, an assist, and a clean sheet (a midfielder, defender or goalie preventing any goals during a game). In addition, the system may award partial points for activities which do not normally receive points in fantasy soccer such as making an accurate pass, completing a successful tackle, and winning a duel. In this way, the athletes' scores change frequently or even constantly, keeping the users 20 engaged in the fantasy competition or contest, as well as in the real-world game or match in which the user's selected athletes are competing.

In step 112, the users 20 may optionally make athlete substitutions. In one embodiment of the present invention, the substitutions permitted in step 112 may be limited. For example, the number of substitutions allowed during a contest may be restricted, such as to the number of substitutions typically allowed in the sport and league of the contest. For example, in fantasy soccer the system 10 may limit the number of substitutions to three, which is the same number generally allowed to managers during a professional soccer game. In this way, the user's experience in the contest mimics that of a real team manager.

The system 10 may further limit the pool of athletes available for substitution to those participating in a game during the time period of the contest. The system 10 may further restrict substitutions by only allowing a user 20 to substitute out athletes who have not started playing in a game yet or are currently playing in a game, while prohibiting the substitution out of athletes who have completed their games. Similarly, the system 10 may allow the substitution in of athletes who have games during the contest but who have not played yet or who are currently playing and have the same amount of time left or more time left in their game than the athlete being substituted out. The system 10 may prohibit the substitution in of athletes who have completed their games. Once an athlete is substituted off of a user's team, that athlete may no longer earn points for that user. Likewise, an athlete who is substituted onto a user's team may begin to accrue points for the user only after the substitution is made. In this way, the system 10 may ensure that the points that will be earned by the athletes for a given user 20 are unknown to the user 20 as they will only be earning the points after the corresponding point in time in the athlete's game at which the substitution is made. In addition, the number of athletes earning points for a user may remain fixed throughout the duration of the contest.

At step 114, the system 10 determines whether or not a substitution limit has been reached for a given user 20. If the limit has not been reached, or if no such limit exists, the user 20 may continue to receive data in step 110 and optionally make substitutions in step 112. If the limit has been reached, the user 20 may continue to receive data about the athletes who remain fixed for the remainder of the contest in step 116. In step 118 the contest is complete at the end of the specified contest period and the winner or winners may be determined by the system 10 based on the users 20 final point total. The contest may end, for example, at the last whistle of all games played during the contest, such as during the contest day. There may be a delay between the end of the last game and the declaration of the winner or winners, to allow for any errors to be corrected and/or any contested plays to be resolved.

In cases in which a game is delayed, such as a delay beyond the scheduled end time of the contest, or in which the game is rescheduled or canceled, the system 10 may remove the athletes who were scheduled to play from the pool of available athletes and may notify any users 20 who have already selected such athletes that they must change their athlete selection. Alternatively, the system 10 may extend the end of the contest and allow the contest to continue including the athletes in the delayed game, such as if the game delay falls within an allowed time window such as one hour or two hours beyond the scheduled end time.

In order for the substitution of athletes during the game to mimic real life athlete substitutions by a manager and to prevent any users 20 from having an unfair advantage, the users 20 may be unaware of how the athletes will perform after they join the user's team. To achieve this as much as possible, the system 10 may employ various techniques as described below.

Data about the athletes may be streamed to the users 20 very quickly, such as instantaneously, in a nearly live or real time manner, whereas broadcasts of sporting events usually have a short delay, such as a delay of a few seconds, between the live action and the viewers observing the broadcast. The data, such as the athletes' points, may therefore are streamed to the users' apps before users typically have the ability to see the athlete's activity in a broadcast. Even if there is no broadcast delay, the data may stream to the users' application, mobile device, or personal computer so quickly that it is practically simultaneous with the corresponding activity in the broadcast game. In this way, a user 20 who is watching a broadcast of a certain sporting event does not have an advantage over other user 20 and all users 20 receive the information at virtually the same instant. If a user 20 could see the game on the broadcast before the data was streamed to users and before the points were counted by the system 10, a user 20 with this advanced knowledge might quickly substitute in an athlete who earned points or substitute out an athlete who lost points prior to these actions being counted by the system 10 and prior to other users 20 who may not be watching the game. By streaming the available data and counting the points for actions usually prior to (or at least virtually simultaneously with) the actions being available to users 20 in a broadcast, the system 10 may prevent, discourage, or even penalize this type of unfair play.

Another way that the system 10 may prevent users 20 from unfairly making use of advanced knowledge is through slowing the process such that athlete substitutions cannot be made instantly, such as with a single click. Rather, the system 10 may require a user 20 to complete multiple steps in order to make an athlete substitution. This is particularly useful to prevent an unfair advantage by user 20 who may be present at a game who will see the athletes' activities before they are tallied and streamed out to users 20 by the system regardless of how quickly the system functions. If users 20 present at a live game could quickly make a substitution, before the system 10 counted the points, they may have an unfair advantage over other users 20. The system 10 therefore may not allow single click types of substitutions. For example, the system 10 may not allow users 20 to have substitutions ready to go and saved in the system, such as by having substitution lists or a bench of athletes ready for substitution or a preset substitution. Rather, the system 10 may require a user 20 to search for an athlete to substitute in and then make the substitution. In this way, a user 20 must complete a plurality of steps such as two, three, or four steps to make a substitution, which may each require a click, resulting in a minimum time delay. Alternatively, or additionally, the system itself may implement a predetermined time delay between receiving the user input to make a substitution and actually completing the substitution, such as if the system 10 allows single click substitutions or pre-set substitutions. The time delay may be greater than the delay of the system between the actual event and the tallying of the points, and indeed may be even longer, to further reduce the advantage and equalize the user experience.

While the use of a time delay may be adequate for most game situations, in some cases an action takes too long to complete for a time delay to nullify the advantage of a user being present at a game. An example of such a situation is a penalty kick in soccer. Because a penalty kick has a significant chance of resulting in an athlete scoring a goal, a user 20 who is present at a game, upon seeing that a penalty kick is going to occur, may substitute that athlete onto the user's team before the potentially point scoring action actually occurs and is tallied and streamed out by the system. The system 10 may therefore neutralize the impact of such substitutions through the point award system. For example, the system 10 may award a point when an athlete scores a goal on a penalty kick but may subtract a point or a partial point when the athlete misses a goal on a penalty kick. The relative points for a positive event (e.g. scoring the penalty kick) and corresponding negative even (e.g. missing the penalty kick) may be set according to the odds that such a positive or negative event will occur on average in order to neutralize the points outcome. In this way, the advantage to substituting an athlete who is about to take a penalty kick onto a users' team is neutralized, since the athlete will either gain a point if the shot is successful or lose a point or partial point if the shot is a miss.

In the foregoing description, the inventions have been described with reference to specific embodiments. However, it may be understood that various modifications and changes may be made without departing from the scope of the inventions.

1. A method of managing a fantasy competition comprising:
creating a fantasy competition;
enrolling of a plurality of participants;
beginning said fantasy competition;
providing data to said plurality of participants during said fantasy competition;
finishing said fantasy competition; and
determining a winner amongst the plurality of participants.

2. The method of claim 1, wherein the step of enrolling of a plurality of participants comprises:
allowing each of the plurality of participants to create a team from a plurality of available athletes.

3. The method of claim 2, wherein the plurality of available athletes comprises a predetermined list of athletes.

4. The method of claim 2, further comprising:
permitting each of the plurality of participants to modify said team to include or remove any of the said plurality of available athletes.

5. The method of claim 4 wherein the step of permitting each of the plurality of participants to modify said team to include or remove any of the said plurality of available athletes may occur prior to or after said step of beginning said fantasy competition.

6. The method of claim 5 wherein the modifications permitted by said step of permitting each of the plurality of participants to modify said team to include or remove any of the said plurality of available athletes may be limited in number.

7. The method of claim 5 wherein the modifications permitted by said step of permitting each of the plurality of participants to modify said team to include or remove any of the said plurality of available athletes may occur while at least one of said available athletes is competing in a real-world sporting event.

8. The method of claim 4, wherein the said step of determining a winner among the plurality of participants comprises awarding points to each participant based on the composition of the participants' team.

9. The method of claim 8, wherein the points awarded correspond to the real-world performance of the available athletes on the participants' team.

10. The method of claim 9, where in the points awarded correspond to the real-world performance of the available athletes while said available athletes were included on the participants' team.

11. A method of managing a fantasy competition comprising:
creating a fantasy competition;
enrolling of a plurality of participants, wherein each of the plurality of participants creates a team from a plurality of available athletes;
beginning said fantasy competition;
permitting each of the plurality of participants to modify said team to include or remove any of the said plurality of available athletes prior to or after said beginning said fantasy competitions;
providing data to said plurality of participants during said fantasy competition;
finishing said fantasy competition;
and determining a winner amongst the plurality of participants.

12. The method of claim 11 wherein the modifications permitted by said step of permitting each of the plurality of participants to modify said team to include or remove any of the said plurality of available athletes may be limited in number.

13. The method of claim 11 wherein the modifications permitted by said step of permitting each of the plurality of participants to modify said team to include or remove any of the said plurality of available athletes may occur while at least one of said available athletes is competing in a real-world sporting event.

14. The method of claim 13, wherein the said step of determining a winner among the plurality of participants comprises awarding points to each participant based on the composition of the participants' team.

15. The method of claim 14, wherein the points awarded correspond to the real-world performance of the available athletes on the participants' team.

16. The method of claim 15, where in the points awarded correspond to the real-world performance of the available athletes while said available athletes were included on the participants' team.

17. A computer-implemented fantasy competition management system, comprising:
a competition server configured to;
create a fantasy competition;
enroll of a plurality of participants;
begin said fantasy competition;
permit each of the plurality of participants to modify said team to include or remove any of the said plurality of available athletes prior to or after said beginning said fantasy competitions,
provide data to said plurality of participants during said fantasy competition;
finish said fantasy competition; and
determine a winner amongst the plurality of participants.

18. The system of claim 17 wherein the permitted modifications are limited in number and may occur while at least one of said available athletes is competing in a real-world sporting event.

19. The system of claim 18, wherein the determination of a winner among the plurality of participants comprises awarding points to each participant based on the composition of the participants' team.

20. The system of claim 19, wherein the points awarded correspond to the real-world performance of the available athletes on the participants' team while said available athletes were included on the participants' team.
